(19) United States
(12) Patent Application Publication
(10) Pub. No.: US 2019/0037032 A1
(43) Pub. Date: Jan. 31, 2019

(54) IP FLOW MIGRATION METHOD, DEVICE AND SYSTEM

(71) Applicant: ZTE CORPORATION, Guangdong (CN)

(72) Inventors: Xiaoyun ZHOU, Guangdong (CN); Xingyue ZHOU, Guangdong (CN)

(21) Appl. No.: 16/069,811

(22) PCT Filed: Nov. 29, 2016
(86) PCT No.: PCT/CN2016/107724

§ 371 Date: Jul. 12, 2018

(30) Foreign Application Priority Data
Jan. 13, 2016 (CN) 201610021966.2

(51) Int. Cl. H04L 29/08; H04W 76/34

(52) U.S. Cl. CPC H04L 67/148; H04L 67/143; H04W 76/34

(57) ABSTRACT

Disclosed in the present disclosure are an IP flow migration method, device and system. The method comprises: a policy and charging rule function (PCRF) entity obtaining trigger information, the trigger information comprising deleting information of an access network from a multi-access IP-CAN session; the PCRF entity determining whether to send instruction information to a policy and charging execution function (PCEF) entity according to the trigger information, the instruction information comprising instructing the PCEF entity to delete an access network from the multi-access IP-CAN session, such that the PCEF entity initiates a process of deleting an access network from the multi-access IP-CAN session. Thus, when a network policy is changed, or when a UE contract is changed, an access network may be deleted from the multi-access IP-CAN session. Therefore, the problem in which IP flow migration cannot be canceled when a network policy is changed, or when a UE contract is changed, can be prevented.

### TECHNICAL FIELD

The present disclosure relates to communication technologies, and in particular to an Internet Protocol (IP) flow mobility method, device, and system.

### BACKGROUND

With the development of communication technologies, the application of the 3rd Generation Partnership Project (3GPP) technology has become more and more widespread.

FIG. 1 is a schematic diagram of a scenario of an Internet Protocol (IP) flow mobility method according to an embodiment in related arts. As shown in FIG. 1, a user equipment (UE), which is covered by both a non-3GPP IP access network and a 3GPP access network at the same time, may establish a multi-access IP-Connectivity Access Network (IP-CAN) session with a network side. The UE may adopt the non-3GPP IP access network to establish, through a Packet Data Network Gateway (P-GW or PDN GW), a connection with an IP service provided by an operator. At the same time, the UE may also establish a connection with an IP service provided by an operator through the P-GW by adopting the 3GPP access network. The P-GW that the UE establishes the connections by using the non-3GPP IP access network and by using the 3GPP access network respectively is the same P-GW, and the P-GW is connected with a Policy and Charging Rules Function (PCRF) entity. It should be noted that, the UE negotiates with the network when initially establishing an IP-CAN session, and the PCRF determines whether a network-based IP flow mobility (NBIFOM) can be applied. When the UE adds an access to establish a multi-access IP-CAN session, the PCRF determines whether the NBIFOM can be applied again.

However, the inventor found that, in the process of implementing the above related art, the above solution cannot determine whether the NBIFOM can be applied when a network policy changes or when a UE subscription changes, thereby being not capable of determining that an access network is deleted from the multi-access IP-CAN session.

### SUMMARY

In order to solve the above technical problem, embodiments of the present disclosure provide an IP flow mobility method, device, and system for solving the problem of being not capable of determining that an access network is deleted from the multi-access IP-CAN session.

For achieving the embodiments of the present disclosure, an embodiment of the present disclosure provides an IP flow mobility method, applied in a scenario that a user equipment (UE) establishes a multi-access IP-CAN session with a packet data network gateway (P-GW) through at least two access networks, which includes the following steps.

A policy and charging rules function (PCRF) entity acquires trigger information. The trigger information includes information for deleting an access network from the multi-access IP-CAN session. The PCRF entity determines to send indication information to a policy and charging enforcement function (PCEF) entity according to the trigger information. The indication information includes indicating the PCEF entity to delete the access network from the multi-access IP-CAN session so as to make the PCEF entity initiate a process of deleting the access network from the multi-access IP-CAN session.

Alternatively, the indication information includes at least one of the following information: indication information for a NBIFOM not supporting, indication information for the NBIFOM not authorizing, or indication information for deleting at least one access network.

Alternatively, the indication information further includes identification information of an access network to be deleted.

Alternatively, the indication information further includes identification information of an access network to be deleted.

Alternatively, the identification information of the access network to be deleted includes IP-CAN type information of the access network to be deleted.

Alternatively, the indication information further includes indication information about migrating a service data flow transmitted in the access network to be deleted to a remaining access network. The remaining access network includes an access network, except for the access network to be deleted, of the at least two access networks.

Alternatively, the trigger information includes one of: information that a network policy changes or information that subscription information of the UE changes.

The present disclosure further provides an internet protocol (IP) flow mobility method, applied in a scenario that a user equipment (UE) establishes a multi-access IP-CAN session with a packet data network gateway (P-GW) through at least two access networks, which includes the following steps.

A PCEF entity receives indication information sent by a PCRF entity. The indication information includes indication information for indicating that the PCEF entity deletes an access network from the multi-access IP-CAN session. The PCEF entity initiates a process of deleting the access network from the multi-access IP-CAN session according to the indication information.

Alternatively, the indication information includes at least one of the following information: indication information for a NBIFOM not supporting, indication information for the NBIFOM not authorizing, or indication information for deleting at least one access network.

Alternatively, the indication information further includes identification information of an access network to be deleted.

Alternatively, the identification information of an access network to be deleted includes IP-CAN type information of the access network to be deleted.

Alternatively, the indication information further includes indication information about migrating a service data flow transmitted in the access network to be deleted to a remaining access network. The remaining access network includes an access network, except for the access network to be deleted, of the at least two access networks.

The present disclosure further provides an internet protocol (IP) flow mobility device, which includes an acquisition module and a determination module.

The acquisition module is configured to acquire trigger information. The trigger information includes information for deleting an access network from a multi-access IP-CAN session.

The determination module is configured to determine to send indication information to a PCEF entity according to the trigger information. The indication information includes indicating the PCEF entity to delete the access network from the multi-access IP-CAN session so as to make the PCEF entity initiates a process of deleting the access network.

Alternatively, the indication information includes at least one of the following information: indication information for a NBIFOM not supporting, indication information for the NBIFOM not authorizing, or indication information for deleting at least one access network.

Alternatively, the indication information further includes identification information of an access network to be deleted.

Alternatively, the identification information of the access network to be deleted includes IP-CAN type information of the access network to be deleted.

Alternatively, the indication information further includes indication information about migrating a service data flow transmitted in the access network to be deleted to a remaining access network. The remaining access network includes an access network, except for the access network to be deleted, of the at least two access networks.

Alternatively, the trigger information includes one of: information that a network policy changes or information that subscription information of the UE changes.

The present disclosure further provides an internet protocol (IP) flow mobility device, which includes a reception module and a deletion module.

The reception module is configured to receive indication information sent by a PCRF entity. The indication information includes indication information indicating that a PCEF entity deletes an access network from a multi-access IP-CAN session.

The deletion module is configured to initiate a process of deleting the access network from the multi-access IP-CAN session according to the indication information.

Alternatively, the indication information includes at least one of the following information: indication information for a NBIFOM not supporting, indication information for the NBIFOM not authorizing, or indication information for deleting at least one access network.

Alternatively, the indication information further includes identification information of an access network to be deleted.

Alternatively, the identification information of the access network to be deleted includes IP-CAN type information of the access network to be deleted.

Alternatively, the indication information further includes indication information about migrating a service data flow transmitted in the access network to be deleted to a remaining access network. The remaining access network includes an access network, except for the access network to be deleted, of the at least two access networks.

The present disclosure further provides an internet protocol (IP) flow mobility system includes the foregoing IP flow mobility device and the foregoing IP flow mobility device.

According to another embodiment of the present disclosure, further provided is a storage medium, and the storage medium is configured to store program codes executing the following steps: acquiring trigger information, in which the trigger information includes information for deleting an access network from a multi-access IP-CAN session; determining to send indication information to a PCEF entity according to the trigger information. The indication information includes indicating the PCEF entity to delete the access network from the multi-access IP-CAN session so as to make the PCEF entity initiate a process of deleting the access network from the multi-access IP-CAN session.

Compared with the related art, the embodiment of the present disclosure includes the followings: the PCRF entity acquires the trigger information, the triggering information includes information for deleting an access network from the multi-access IP-CAN session; the PCRF entity determines, according to the trigger information, to send the indication information the PCEF entity, the indication information includes indicating the PCEF entity to delete the access network from the multi-access IP-CAN session, so as to make the PCEF entity initiate a process of deleting the access network from the multi-access IP-CAN session. It is implemented to delete an access network from a multi-access IP-CAN session when the network policy changes or when the UE subscription changes. The problem that the IP flow mobility cannot be canceled when the network policy changes or when the UE subscription changes can be avoided.

Other features and advantages of the present disclosure will be set forth in the following detail description, and they become partially visible according to the detail description, or they are known according to the implementation of the present disclosure. The objectives and other advantages of the present disclosure will be realized and obtained by structures specified in the detail description, claims and the drawings.

### BRIEF DESCRIPTION OF DRAWINGS

The drawings described herein are used to provide a further understanding of the present disclosure and form a part of the present application. The exemplary embodiments of the present disclosure and its description are used to explain the present disclosure and not to limit the present disclosure in an improper way. In the drawings:

FIG. 1 is a schematic diagram of a scenario of an IP flow mobility method according to an embodiment in related arts;

FIG. 2 is a flowchart of a first IP flow mobility method according to an embodiment of the present disclosure;

FIG. 3 is a flowchart of a second IP flow mobility method according to an embodiment of the present disclosure;

FIG. 4 is a flowchart of a third IP flow mobility method according to an embodiment of the present disclosure;

FIG. 5 is a flowchart of a fourth IP flow mobility method according to an embodiment of the present disclosure;

FIG. 6 is a flowchart of a fifth IP flow mobility method according to an embodiment of the present disclosure;

FIG. 7 is a schematic diagram of a first IP flow mobility device according to an embodiment of the present disclosure; and

FIG. 8 is a schematic diagram of a second IP flow mobility device according to an embodiment of the present disclosure.

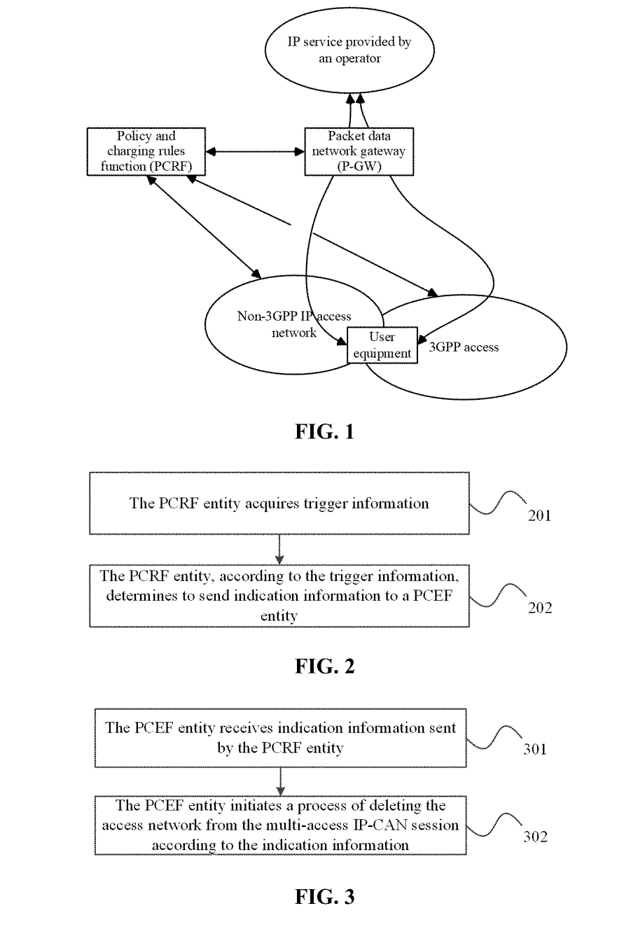

### DETAILED DESCRIPTION

The embodiments of the present disclosure will be described hereinafter in detail with reference to the drawings to make the purposes, technical solutions and advantages more clearly.

It should be noted that, if not in collision, the embodiments and features therein in the present application can be combined with each other.

The IP flow mobility method provided by the embodiments of the present disclosure may be applied in a scenario that a user equipment (UE) establishes a multi-access IP-CAN session with a P-GW through at least two access networks, as well as a network policy is changed or subscription information of the UE is changed. The two access networks may include a first access network and a second access network. For example, the two access networks may include a 3GPP access network and a non-3GPP access network. The IP flow mobility method provided by the embodiment may be implemented by an IP flow mobility device. The IP flow mobility device may be integrated in a PCRF entity or a P-GW, or may be set separately, and the IP flow mobility device may implement by adopting at least one of the following ways: software or hardware. The IP flow mobility method and device provided in the embodiment will be described in detail hereinafter.

FIG. 2 is a flowchart of a first IP flow mobility method according to an embodiment of the present disclosure. As shown in FIG. 2, the executor of the embodiment may be a PCRF entity, and the IP flow mobility method provided by the present disclosure is applied in a scenario that a UE establishes a multi-access IP-CAN session with a P-GW through at least two access networks. The IP flow mobility method includes the following steps.

In step 201, the PCRF entity acquires trigger information, and the trigger information includes information for deleting an access network from the multi-access IP-CAN session.

In this embodiment, the trigger information may include one of information that the network policy changes or information that subscription information of the UE changes.

In step 202, the PCRF entity, according to the trigger information, determines to send indication information to a policy and charging enforcement function (PCEF) entity.

In this embodiment, the indication information includes indicating the PCEF entity to delete one access network from the multi-access IP-CAN session so as to make the PCEF entity initiate a process of deleting the access network from the multi-access IP-CAN session.

In this embodiment, the indication information is used for indicating the PCEF entity to delete the access network from the multi-access IP-CAN session.

For example, the indication information includes at least one of the following information: indication information for a NBIFOM not supporting, indication information for the NBIFOM not authorizing, or indication information for deleting at least one access network.

In one exemplary embodiment, on the basis of the foregoing embodiments, the policy and charging rules information may further include identification information of an access network to be deleted.

In one exemplary embodiment, on the basis of the foregoing embodiments, the identification information of the access network to be deleted includes IP-CAN type information of the access network to be deleted.

In one exemplary embodiment, on the basis of the foregoing embodiments, the indication information may further include: indication information about migrating a service data flow transmitted in the access network to be deleted to a remaining access network. The remaining access network includes an access network, except for the access network to be deleted, of the at least two access networks.

In the embodiment, the PCRF entity acquires the trigger information, and the triggering information includes information for deleting an access network from the multi-access IP-CAN session; the PCRF entity determines to send indication information to the PCEF entity according to the trigger information, and the indication information includes indicating the PCEF entity to delete one access network from the multi-access IP-CAN session so as to make the PCEF entity initiate a process of deleting the access network from the multi-access IP-CAN session. It is implemented to delete an access network from the multi-access IP-CAN session when the network policy changes or the UE subscription changes. The problem that the IP flow mobility cannot be canceled when the network policy changes or when the UE subscription changes is avoided.

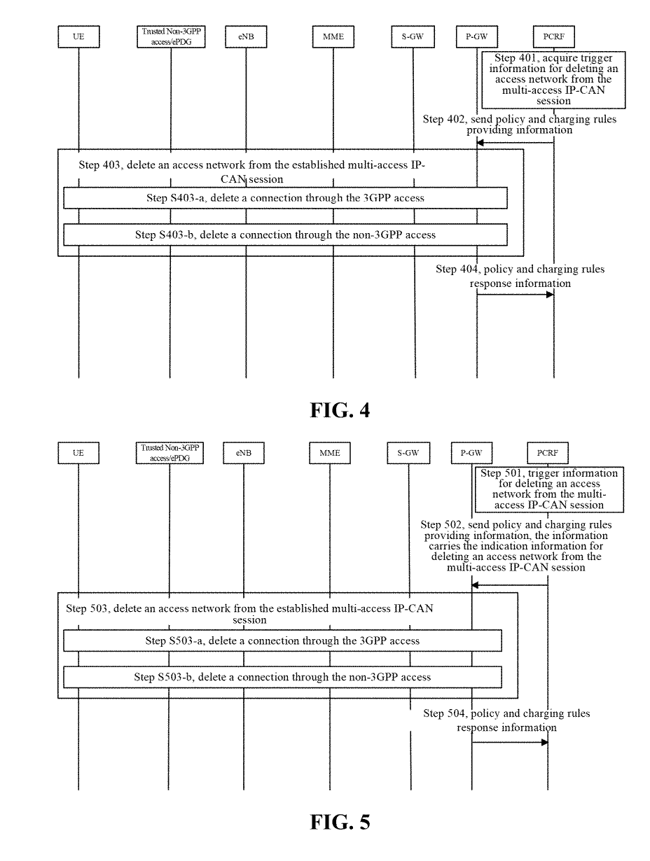

FIG. 3 is a flowchart of a second IP flow mobility method according to an embodiment of the present disclosure. As shown in FIG. 3, the executor of the embodiment may be a PCEF entity, and the IP flow mobility method provided by the present disclosure is applied in a scenario that a UE establishes a multi-access IP-CAN session with a P-GW through at least two access networks. The IP flow mobility method includes the following steps.

In step 301, the PCEF entity receives indication information sent by the PCRF entity.

In this embodiment, the indication information includes indication information about indicating that an access network is deleted from the multi-access IP-CAN session.

In this embodiment, the indication information is used for indicating the PCEF initiates a process of deleting the access network from the multi-access IP-CAN session.

For example, the indication information includes at least one of the following information: indication information for a NBIFOM not supporting, indication information for the NBIFOM not authorizing, or indication information for deleting at least one access network.

In one exemplary embodiment, on the basis of the foregoing embodiments, the indication information may further include: identification information of an access network to be deleted.

In one exemplary embodiment, on the basis of the foregoing embodiments, the identification information of the access network to be deleted is IP-CAN type information of the access network to be deleted.

In one exemplary embodiment, on the basis of the foregoing embodiments, the indication information may further include indication information about migrating a service data flow transmitted in the access network to be deleted to a remaining access network.

In step 302, the PCEF entity initiates a process of deleting the access network from the multi-access IP-CAN session according to the indication information.

In this embodiment, the step that the PCEF entity deletes the access network from the multi-access IP-CAN session according to the indication information includes at least the following implementations.

A first implementation, the PCEF deletes one access network of the multi-access IP-CAN session according to the indication information and a configuration policy. The indication information includes at least one of the following information: indication information for the NBIFOM not supporting, indication information for the NBIFOM not authorizing, or indication information for deleting at least one access network.

A second implementation, according to the indication information and the identification information of the access network to be deleted, the PCEF deletes an access network, which is identified by the identification information, in the multi-access IP-CAN session. The indication information includes at least one of the following information: indication information for the NBIFOM not supporting, indication information for the NBIFOM not authorizing, or indication information for deleting at least one access network. The identification information of the access network to be deleted is IP-CAN type information of the access network.

A third implementation, on the basis of the foregoing second implementation, service data flow(s) transmitted in the deleted access network migrates to a remaining access network. The indication information, on the basis of the first or second implementation, may further include migrating the service data flow(s) transmitted in the access network to be deleted to the remaining access network.

In this embodiment, the PCEF entity receives the indication information sent by the PCRF entity, and the indication information includes indication information for indicating that the PCEF entity deletes an access network from the multi-access IP-CAN session; the PCEF entity initiates a process of deleting the access network from the multi-access IP-CAN session according to the indication information. It is implemented to delete an access network from the multi-access IP-CAN session when the network policy changes or when the UE subscription changes. The problem that the IP flow mobility cannot be canceled when the network policy changes or when the UE subscription changes is avoided.

FIG. 4 is a flowchart of a third IP flow mobility method according to an embodiment of the present disclosure. As shown in FIG. 4, the applicable scenario of the embodiment is that the indication information includes at least one of the following information: indication information of NBIFOM not supporting the IP-CAN session, indication information of NBIFOM not authorizing the IP-CAN session, or indication information for deleting at least one access network. It should be noted that the PCRF entity is configured in the P-GW. The IP flow mobility method provided by the present disclosure includes the following steps.

In step 401, the PCRF entity acquires trigger information for deleting an access network from the multi-access IP-CAN session.

In this embodiment, the triggering information may include that: a network policy changes, or subscription information of the UE changes. That is, the PCRF determines that the network-based IP flow mobility is not applicable to the IP-CAN session. The IP-CAN session includes the multi-access IP-CAN session established by the UE with the P-GW through at least two access networks.

In step 402, the PCRF entity sends policy and charging rules providing information to the PCEF entity, and the information carries the indication information for deleting an access network from the multi-access IP-CAN session.

In the embodiment, the indication information is used for triggering a process that the PCEF deletes an access network from the multi-access IP-CAN session. The indication information includes at least one of the following information: indication information for a NBIFOM not supporting, indication information for the NBIFOM not authorizing, or indication information for deleting at least one access network.

In step 403, the PCEF deletes the access network from the established multi-access IP-CAN session according to the indication information and the configuration policy.

In an exemplary embodiment, execute step S403-a or step S403-b.

For example, in step S403-a, the PCEF deletes a connection through the 3GPP access according to the indication information and the configuration policy. In the detailed implementation, the P-GW where the PCEF is located initiates a process of a P-GW initiated bearer deactivation to delete a default bearer and all dedicated bearers in the 3GPP access, but the P-GW may maintain the IP address.

In step S403-b, the PCEF deletes a connection through the non-3GPP access according to the indication information and the configuration policy. In the detailed implementation, the P-GW where the PCEF is located initiates a process of a P-GW initiated resource allocation deactivation to delete a default bearer and all dedicated bearers in the non-3GPP access, but the P-GW may maintain the IP address.

In step 404, the PCEF sends policy and charging rules providing response information to the PCRF.

It should be noted that, before executing the step S403-a, the PCEF may migrate service flows transmitted in the 3GPP access to the non-3GPP access; or before executing the step S403-b, the PCEF may migrate service flows transmitted in the non-3GPP access to the 3GPP access.

FIG. 5 is a flowchart of a fourth IP flow mobility method according to an embodiment of the present disclosure. As shown in FIG. 5, the applicable scenario of the embodiment is that: on the basis of the indication information including at least one of the following information: indication information for a NBIFOM not supporting, indication information for the NBIFOM not authorizing, or indication information for deleting at least one access network, the policy and charging rules information may further include identification information of an access network to be deleted. It should be noted that the PCRF entity is configured in the P-GW. The IP flow mobility method provided by the present disclosure includes the following steps.

In step 501, the PCRF entity acquires trigger information for deleting an access network from the multi-access IP-CAN session.

In the embodiment, the triggering information may include that: a network policy changes or subscription information of the UE changes. That is, the PCRF determines that a network-based IP flow mobility has been not applicable to the IP-CAN session. The IP-CAN session includes the multi-access IP-CAN session established by the UE with the P-GW through at least two access networks.

In step 502, the PCRF entity sends policy and charging rules providing information to the PCEF entity, and the information carries the indication information for deleting an access network from the multi-access IP-CAN session.

In the embodiment, the indication information is used for triggering the PCEF to initiate a process of deleting the access network from the multi-access IP-CAN session. On the basis that the indication information includes at least one of the following information: indication information for a NBIFOM not supporting, indication information for the NBIFOM not authorizing, or indication information for deleting at least one access network, the indication information may further include identification information of an access network to be deleted. The identification information may be IP-CAN type indication information (that is, 3GPP_Evolved Packet System (EPS) or Non_3GPP_EPS).

In step 503, the PCEF deletes an access network from the established multi-access IP-CAN session according to the indication information.

Specifically, if the indication information of an access network that needs to be deleted indicates that the 3GPP access network is deleted, then execute step S503-a. If the indication information of an access network that needs to be deleted indicates that the non-3GPP access network is deleted, then execute step S503-b.

In step S503-a, a connection through the 3GPP access is deleted. In the detailed implementation, the P-GW where the PCEF is located initiates a process of a P-GW initiated bearer deactivation to delete a default bearer and all dedicated bearers in the 3GPP access, but the P-GW may maintain the IP address.

In step S503-b, a connection through the non-3GPP access is deleted. In the detailed implementation, the P-GW where the PCEF is located initiates a process of a P-GW initiated resource allocation deactivation to delete a default bearer and all dedicated bearers in the non-3GPP access, but the P-GW may maintain the IP address.

In step 504, the PCEF sends policy and charging rules providing response information to the PCRF.

It should be noted that, before executing the step S703-a, the PCEF may migrate service flows transmitted in the 3GPP access to the non-3GPP access; or before executing the step S703-b, the PCEF may migrate service flows transmitted in the non-3GPP access to the 3GPP access.

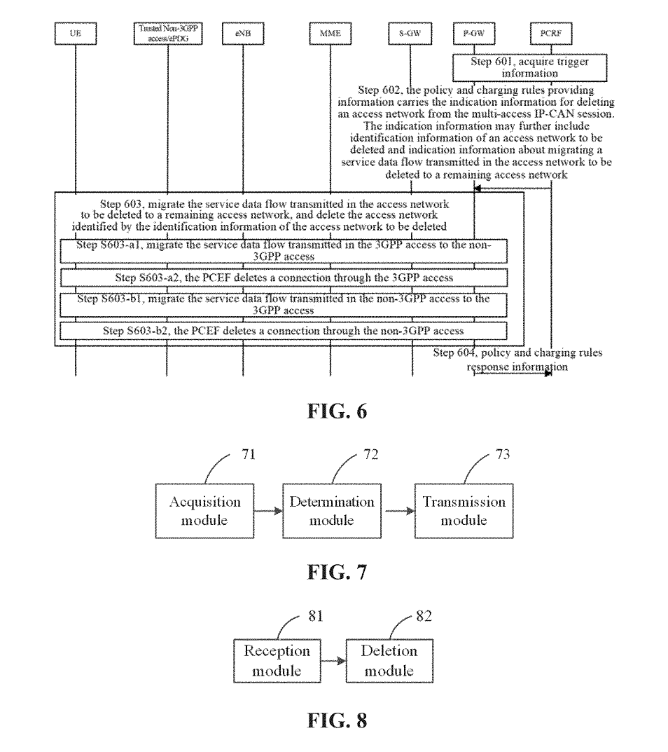

FIG. 6 is a flowchart of a fifth IP flow mobility method according to an embodiment of the present disclosure. As shown in FIG. 6, the applicable scenario of the embodiment is that: on the basis of that indication information includes the indication information in the embodiment shown in FIG. 5, the indication information may further include migrating a service data flow transmitted in an access network to be deleted to a remaining access network. The IP flow mobility method provided by the present disclosure includes the following steps.

In step 601, the PCRF entity acquires trigger information, and the trigger information is information for deleting an access network from the multi-access IP-CAN session.

In the embodiment, the triggering information may include that: a network policy changes or subscription information of the UE changes. That is, the PCRF determines that a network-based IP flow mobility is not applicable to the IP-CAN session already. The IP-CAN session includes the multi-access IP-CAN session established by the UE with the P-GW through at least two access networks.

In step 602, the PCRF entity sends policy and charging rules providing information to the PCEF entity, and the policy and charging rules providing information carries the indication information for deleting an access network from the multi-access IP-CAN session. The indication information may further include identification information of an access network to be deleted and indication information about migrating a service data flow transmitted in the access network to be deleted to a remaining access network.

In the embodiment, the indication information is used for triggering the PCEF to delete an access network from the multi-access IP-CAN session. The indication information includes at least one of the following information: indication information for a NBIFOM not supporting, indication information for the NBIFOM not authorizing, or indication information for deleting at least one access network. The indication information may further include identification information of an access network to be deleted and indication information about migrating a service data flow transmitted in the access network to be deleted to a remaining access network.

In step 603, the P-GW migrates the service data flow transmitted in the access network to be deleted to a remaining access network according to the indication information (in which the indication information may be a policy and charging control (PCC) rule of migrating the service data flow from the access network to be deleted to the remaining access network), and the access network identified by the identification information of the access network to be deleted is deleted.

Specifically, if the indication information of an access network that needs to be deleted indicates to delete the 3GPP access, then execute step 603-a1 and step 603-a2. If the indication information of an access network that needs to be deleted indicates to delete the non-3GPP access, then execute step 603-b1 and step 603-b2.

In step S603-a1, the PCEF migrates the service data flow transmitted in the 3GPP access to the non-3GPP access according to the PCC rule.

In step S603-a2, the PCEF deletes a connection through the 3GPP access. In the detailed implementation, the P-GW where the PCEF is located initiates a process of a P-GW initiated bearer deactivation to delete a default bearer and all dedicated bearers in the 3GPP access, but the P-GW may maintain the IP address.

In step S603-b1, the PCEF migrates the service data flow transmitted in the non-3GPP access to the 3GPP access according to the PCC rule.

In step S603-b2, the PCEF deletes a connection through the non-3GPP access. In the detailed implementation, the P-GW where the PCEF is located initiates a process of a P-GW initiated resource allocation deactivation to delete a default bearer and all dedicated bearers in the non-3GPP access, but the P-GW may maintain the IP address.

In step 604, the PCEF sends policy and charging rules providing response information to the PCRF.

FIG. 7 is a schematic diagram of a first IP flow mobility device according to an embodiment of the present disclosure. As shown in FIG. 7, the IP flow mobility device provided by the present disclosure includes: an acquisition module 71, a determination module 72, and a transmission module 73.

The acquisition module 71 is configured to acquire trigger information, and the trigger information includes information for deleting an access network from the multi-access IP-CAN session.

The determination module 72 is configured to determine to send indication information to the PCEF entity according to the trigger information, and the indication information includes indicating the PCEF entity to delete the access network from the multi-access IP-CAN session, so as to make the PCEF entity initiates a process of deleting the access network.

In the embodiment, the PCRF entity acquires the trigger information, and the triggering information includes information for deleting an access network from the multi-access IP-CAN session; the PCRF entity determines to send indication information to the PCEF entity according to the trigger information, and the indication information includes indicating the PCEF entity to delete one access network from the multi-access IP-CAN session so as to make the PCEF entity initiate a process of deleting the access network from the multi-access IP-CAN session. It is implemented to delete an access network from the multi-access IP-CAN session when the network policy changes or the UE subscription changes. The problem that the IP flow mobility cannot be canceled when the network policy changes or when the UE subscription changes is avoided.

On the basis of the foregoing embodiments, the indication information includes at least one of the following information: indication information for a NBIFOM not supporting, indication information for the NBIFOM not authorizing, or indication information for deleting at least one access network.

In one exemplary embodiment, on the basis of the foregoing embodiments, the indication information further includes identification information of an access network to be deleted.

In one exemplary embodiment, on the basis of the foregoing embodiments, the identification information of the access network to be deleted includes IP-CAN type information of the access network to be deleted.

In one exemplary embodiment, on the basis of the foregoing embodiments, the indication information further includes: indication information about migrating a service data flow transmitted in the access network to be deleted to a remaining access network. The remaining access network includes an access network, except for the access network to be deleted, of the at least two access networks.

In one exemplary embodiment, on the basis of the foregoing embodiments, the trigger information includes information that a network policy changes or information that subscription information of the UE changes.

In the embodiment, it is implemented to delete an access network from the multi-access IP-CAN session when the network policy changes or the UE subscription changes. The problem that the IP flow mobility cannot be canceled when the network policy changes or when the UE subscription changes is avoided.

FIG. 8 is a schematic diagram of a second IP flow mobility device according to an embodiment of the present disclosure. As shown in FIG. 8, the IP flow mobility device provided by the present disclosure includes a reception module 81 and a mobility module 82.

The reception module 81 is configured to receive indication information sent by a PCRF entity, and the indication information includes indication information indicating that a PCEF entity deletes an access network from a multi-access IP-CAN session;

The deletion module 82 is configured to initiate a process of deleting the access network from the multi-access IP-CAN session according to the indication information.

In the embodiment, the PCEF entity receives the indication information sent by the PCRF entity, and the indication information is used for triggering the PCEF entity to initiate a process of deleting an access network from the multi-access IP-CAN session; the PCEF entity initiates the process of deleting the access network from the multi-access IP-CAN session according to the indication information. It is implemented to delete an access network from the multi-access IP-CAN session when the network policy changes or when the UE subscription changes. The problem that the IP flow mobility cannot be canceled when the network policy changes or when the UE subscription changes is avoided

On the basis of the foregoing embodiments, the indication information includes at least one of the following information: indication information for a NBIFOM not supporting, indication information for the NBIFOM not authorizing, or indication information for deleting at least one access network.

The deleting module initiates a process of deleting the access network from the multi-access IP-CAN session according to the indication information.

In one exemplary embodiment, on the basis of the foregoing embodiments, the indication information includes at least one of the following information: indication information for a NBIFOM not supporting, indication information for the NBIFOM not authorizing, or indication information for deleting at least one access network.

In one exemplary embodiment, on the basis of the foregoing embodiments, the indication information further includes identification information of the access network to be deleted.

In one exemplary embodiment, on the basis of the foregoing embodiments, the identification information of an access network to be deleted includes IP-CAN type information of the access network to be deleted.

In one exemplary embodiment, on the basis of the foregoing embodiments, the indication information further includes indication information about migrating a service data flow transmitted in the access network to be deleted to a remaining access network. The remaining access network includes an access network, except for the access network to be deleted, of the at least two access networks.

In the embodiment, it is implemented to delete an access network from the multi-access IP-CAN session when the network policy changes or the UE subscription changes. The problem that the IP flow mobility cannot be canceled when the network policy changes or when the UE subscription changes is avoided.

The present disclosure further provides an IP flow mobility system, including: an IP flow mobility device shown in FIG. 7 and an IP flow mobility device shown in FIG. 8.

While the embodiments disclosed by the present disclosure have been described above, the described embodiments are merely for the purpose of understanding the present disclosure and not intending to limit the present disclosure. Any modification and variation in the form and details of the embodiments may be made by those skilled in the art without departing from the spirit and scope of the present disclosure. The protection scope of the present disclosure defined by the appended claims shall prevail.

### INDUSTRIAL APPLICABILITY

Embodiments of the present disclosure include that: the PCRF entity acquires the trigger information, and the triggering information includes information for deleting an access network from the multi-access IP-CAN session; the PCRF entity determines to send indication information to the PCEF entity according to the trigger information, and the indication information includes indicating the PCEF entity to delete one access network from the multi-access IP-CAN session so as to make the PCEF entity initiate a process of deleting the access network from the multi-access IP-CAN session. It is implemented to delete an access network from the multi-access IP-CAN session when the network policy changes or the UE subscription changes. The problem that the IP flow mobility cannot be canceled when the network policy changes or when the UE subscription changes is avoided.

1. An internet protocol (IP) flow mobility method, for establishing, by a user equipment (UE), a multi-access IP-connectivity access network (IP-CAN) session with a packet data network gateway (P-GW) through at least two access networks, the method comprising:
acquiring, by a policy and charging rules function (PCRF) entity, trigger information, wherein the trigger information comprises information for deleting an access network from the multi-access IP-CAN session; and
determining, by the PCRF entity according to the trigger information, to send indication information to a policy and charging enforcement function (PCEF) entity, wherein the indication information comprises information indicating to the PCEF entity to delete the access network from the multi-access IP-CAN session in order to make the PCEF entity initiate deleting the access network from the multi-access IP-CAN session.

2. The method according to claim 1, wherein the indication information comprises at least one of the following information:
indication information for not supporting a network-based IP flow mobility (NBIFOM), indication information for not authorizing the NBIFOM, or indication information for deleting at least one access network.

3. The method according to claim 1, wherein the indication information further comprises: identification information of an access network to be deleted.

4. The method according to claim 3, wherein the identification information of the access network to be deleted comprises IP-CAN type information of the access network to be deleted.

5. The method according to claim 3, wherein the indication information further comprises: indication information about migrating a service data flow transmitted in the access network to be deleted to a remaining access network, wherein the remaining access network comprises an access network, except for the access network to be deleted, of the at least two access networks.

6. The method according to claim 1, wherein the trigger information comprises one of: information of a change in a network policy, or information of a change in subscription information of the UE.

7. An internet protocol (IP) flow mobility method, for establishing, by a user equipment (UE) a multi-access IP connectivity access network (IP-CAN) session with a packet data network gateway (P-GW) through at least two access networks, the method comprising:
receiving, by a policy and charging enforcement function (PCEF) entity, indication information sent by a policy and charging rules function (PCRF) entity, wherein the indication information comprises indication information indicating that the PCEF entity deletes an access network from the multi-access IP-CAN session; and
initiating, by the PCEF entity according to the indication information, deleting the access network from the multi-access IP-CAN session.

8. The method according to claim 7, wherein the indication information comprises at least one of the following information: indication information for not supporting a network-based IP flow mobility (NBIFOM), indication information for not authorizing the NBIFOM, or indication information for deleting at least one access network.

9. The method according to claim 7, wherein the indication information further comprises: identification information of an access network to be deleted.

10. The method according to claim 9, wherein the identification information of the access network to be deleted comprises IP-CAN type information of the access network to be deleted.

11. The method according to claim 9, wherein the indication information further comprises: indication information about migrating a service data flow transmitted in the access network to be deleted to a remaining access network, wherein the remaining access network comprises an access network, except for the access network to be deleted, of the at least two access networks.

12. An internet protocol (IP) flow mobility device, wherein the device comprises:
an acquisitioner configured to acquire trigger information, wherein the trigger information comprises information for deleting an access network from a multi-access IP connectivity access network (IP-CAN) session; and
a determiner configured to determine to send indication information to a policy and charging enforcement function (PCEF) entity according to the trigger information, wherein the indication information comprises information indicating to the PCEF entity to delete the access network from the multi-access IP-CAN session in order make the PCEF entity initiate deleting the access network.

13. The device according to claim 12, wherein the indication information comprises at least one of the following information: indication information for not supporting a network-based IP flow mobility (NBIFOM), indication information for not authorizing the NBIFOM, or indication information for deleting at least one access network.

14. The device according to claim 12, wherein the indication information further comprises: identification information of an access network to be deleted.

15. The device according to claim 14, wherein the identification information of the access network to be deleted comprises IP-CAN type information of the access network to be deleted.

16. The device according to claim 14, wherein the indication information further comprises: indication information about migrating a service data flow transmitted in the access network to be deleted to a remaining access network, wherein the remaining access network comprises an access network, except for the access network to be deleted, of at least two access networks.

17. The device according to claim 12, wherein the trigger information comprises one of: information of a change in a network policy, or information of a change in subscription information of the UE.

18-22. (canceled)

23. An internet protocol (IP) flow mobility system, comprising: the IP flow mobility device according to claim 12, wherein the IP flow mobility device further comprises: a receptioner and a deleter; wherein:
the receptioner configured to receive indication information sent by the PCRF entity, wherein the indication information comprises indication information indicating that the PCEF entity deletes an access network from a multi-access IP connectivity access network (IP-CAN) session; and
the deleter configured to initiate deleting the access network from the multi-access IP-CAN session according to the indication information.

24. The device according to claim 23, wherein the indication information comprises at least one of the following information: indication information for not supporting a network-based IP flow mobility (NBIFOM), indication information for not authorizing the NBIFOM, or indication information for deleting at least one access network.

25. The device according to claim 24, wherein the indication information further comprises: identification information of an access network to be deleted; and
wherein the identification information of the access network to be deleted comprises IP-CAN type information of the access network to be deleted.
